(19) United States
(12) Patent Application Publication
(10) Pub. No.: US 2023/0236381 A1
(43) Pub. Date: Jul. 27, 2023

(54) METHODS AND APPARATUS FOR REMOTELY LAYING CABLE

(71) Applicant: 225278 ALBERTA INC., Airdrie (CA)

(72) Inventor: Jared Johan FISK, Airdrie (CA)

(21) Appl. No.: 18/002,659

(22) PCT Filed: Jun. 22, 2021
(86) PCT No.: PCT/CA2021/050860

§ 371 Date: Dec. 20, 2022

Related U.S. Application Data
(60) Provisional application No. 63/042,842, filed on Jun. 23, 2020.

(51) Int. Cl. G02B 6/50; H02G 1/06; B62D 57/024

(52) U.S. Cl. CPC G02B 6/50; B62D 57/024; H02G 1/06

(57) ABSTRACT

Apparatus and methods for remotely laying cable. A crawler comprises a propulsion means for moving the crawler along a surface. A controller stores the route followed by the crawler. As the crawler moves along the surface a cable is fed onto the surface. A fastener is then used to affix the cable to the surface.

### FIELD OF THE INVENTION

The invention generally relates to laying cable remotely. In particular, the technology relates to affixing fiber optic cable along a path remotely using a crawler.

### BACKGROUND

Climbing robots or crawlers are used for a variety of applications, such as window cleaning, structural inspections, reconnaissance and sensor deployment. They are typically used to inspect the surface of a structure remotely.

One such structure is a storage tank, such as a floating roof tank, which is a storage tank commonly used to store large quantities of petroleum products such as crude oil or condensate. It typically comprises a cylindrical shell equipped with a roof that floats on the surface of the stored liquid. The roof rises and falls with the liquid level in the tank. This helps to eliminate tank breathing loss and to reduce the evaporative loss of the stored liquid.

There is typically a rim seal assembly between the tank shell and roof to reduce rim evaporation. The seals are somewhat flexible in nature to navigate the shell deformations and welds that are present on the shell.

US 2014/216,836 discloses a robotic climbing platform has a chassis and a carriage adapted to support and move the chassis relative to a climbing surface. An adhesion mechanism provides an adhesion force between the climbing platform and the climbing surface. The adhesion mechanism has one or more suction pads adapted to retain an adhesion force between the climbing platform and the climbing surface during movement of the chassis relative to the climbing surface.

### SUMMARY

According to a first aspect of the present disclosure, there is provided a crawler for laying cable (or a cable assembly) comprising:
propulsion means configured to move the crawler along a surface;
a controller configured to store a route followed by the crawler as it moves along the surface;
a cable feeder configured to feed a cable or cable assembly onto the surface as the crawler moves along the surface; and
a fastener applicator configured to position a fastener with respect to the cable or cable assembly as it is being fed onto the surface to affix the cable to the surface.

The controller may be configured to control the propulsion means along a predetermined route. For example, a route may be determined in advance using a digital representation (digital twin) of the structure. The route may comprise a path along the surface of the structure. The route may be completely specified in advance (e.g. comprising a series of instructions on how the propulsion means should be controlled to follow the path. E.g. forward 1 meter, turn 45°, forward 2 meters etc.).

The controller may be configured to store onboard the route followed by the crawler as it moves along the surface (i.e. on a memory which is mounted to the crawler). The controller may be configured to store remotely the route followed by the crawler as it moves along the surface (e.g. by transmitting the data to a remote computer).

The controller may be configured to record operation of the propulsion means as it moves along a route. The controller may be configured to configured to associate a route followed by the crawler with operation of the propulsion means (e.g. as the wheels move forward and steer the route is calculated).

The controller may be configured to navigate the structure in a predetermined manner using real time feedback from sensors. For example, the crawler may be configured to lay the cable or cable assembly by moving along with respect to a feature on or near the crawler (e.g. a wall, rail, seam or weld).

The crawler may be controlled remotely by a user (e.g. using wireless control).

The crawler may comprise magnets for attaching the crawler to the surface (e.g. a ferromagnetic surface such as iron or steel). The propulsion means may be magnetic. The propulsion means may comprise tracks (e.g. a continuous band of treads or track plates driven by one or more wheels). The crawler may comprise suction means to attach the crawler to a surface. The suction means may comprise a skirt for enclosing a volume between the crawler and the surface, and a fan for evacuating air from the enclosed volume. The suction means may comprise suction cups.

The feeder may comprise a magnetic wheel to lay the cable or cable assembly down. The magnetic wheel may help ensure that the feeder maintains contact with the surface. The feeder may be resiliently mounted (e.g. using a spring) to apply the cable or cable assembly onto the surface with a force.

The crawler may be articulated (e.g. comprise a trailer). The feeder may be mounted on an axis between two wheels which have a fixed angle with respect to the axis. This may help ensure that the feeder is aligned with the movement of the crawler.

The crawler may comprise a reader configured to read indicia from the cable or cable assembly as the cable or cable assembly is being fed onto the surface. The indicia may comprise bar codes, markings, protrusions and/or notches.

The reader may be configured to read each indicium, wherein the controller is configured to associate the read indicium with a position along the route.

The crawler may comprise an orientation means configured to orient the cable or cable assembly before it is fed onto the surface. The orientation means may comprise a non-rotationally-symmetric aperture through which a cable or cable assembly with a corresponding non-rotationally-symmetric cross-section must pass. The cable or cable assembly may comprise a notch or a grove along the length of the cable or cable assembly.

The crawler may comprise an orientation means is configured to orient a flat side of the cable or cable assembly such that the flat side is facing the surface when the cable or cable assembly is fed onto the surface.

The fastener applicator may be configured to apply liquid glue to the surface and the cable or cable assembly to fasten the cable or cable assembly to the surface. The crawler may comprise a curing means configured to interact with the liquid glue to speed curing. The curing means may comprise a UV light (for light-curing glues), a heater, an air blower and/or a humidifier (for glues which cure in response to water exposure). The fastener may comprise glue. The fastener may comprise adhesive tape. The fastener may comprise clips. The fastener may comprise staples.

Depending on the glue, the cable or cable assembly may be encased with a glue fluid in liquid form as it is fed through the feeder with the glue acting as a lubricant and a preserver to the cable. In this way, the cable or cable assembly is continuously lubricated while spooling. After being laid, the liquid glue may be cured using a curing means (e.g. using UV light). In such embodiments, the cable may be stored in an air-tight reel before being fed into the feeder.

The cable feeder may be configured to feed a cable or cable assembly comprising a fastener (such as a layer of solid glue, e.g. attached to the cladding of the cable) and a fastener protective layer (e.g. a flexible layer of plastic or paper), and wherein the fastener applicator is configured to remove the protective layer to expose the fastener as the cable is fed onto the surface.

The crawler may comprise a cleaner configured to clean a portion of the surface prior to application of the cable or cable assembly. The cleaner may comprise a brush and/or a steam cleaner.

The crawler may comprise a reel configured to hold the cable and direct the cable or cable assembly into the feeder. Using a reel may help ensure that the orientation of the cable or cable assembly is consistent as it is fed into the feeder.

A cable assembly may be a cable. A cable assembly may comprise one or more cables and other components (e.g. a fastener, indicia, components for holding multiple fiber optic cables together in a fixed orientation with respect to each other). A cable assembly may be configured to hold, secure or interact with a cable.

The cable may comprise, or be, a fiber optic cable. The cable may be an instrumentation, control and/or electrical cable. The cable may be configured to transmit information. The cable may be non-structural cable (e.g. attached to the structure, but not providing support for the structure). The cable may comprise one or more claddings and/or coatings. The cladding may be configured to encase and protect a core. The cladding may comprise plastic and/or rubber. The cladding may interact with the core to allow the core to carry out its function (e.g. the cladding of a fiber-optic cable might have a refractive index to allow total internal reflection within the core). The cable may comprise a core. The core may be configured to transmit electricity (e.g. wire) or light (e.g. a fiber-optic core) The cable may be flexible. The cable may comprise an insulated wire or wires having a protective casing and used for transmitting electricity or telecommunication signals.

The cable assembly may comprise a guide for receiving a cable (e.g. wire or fiber optic cable). For example, the guide may be a sheath be affixed to a structure and then the fiber optic cable may be inserted into the sheath by feeding the fiber optic cable into one end. The sheath may be formed from a plastic and/or a polymer. The sheath may be an elongate conduit or channel which is enclosed along the length of the sheath. The sheath may comprise openings at one or both ends.

The crawler may comprise a feeder for inserting and feeding a fiber optic cable (or assembly comprising a fiber optic cable) into the sheath and/or for removing a fiber optic cable (or assembly comprising a fiber optic cable) from the sheath. The crawler may comprise a reel for holding the fiber optic cable while it is being inserted into or removed from the sheath.

A guide may comprise one or more engageable locks for securing the fiber optic cable to the guide to prevent the fiber optic cable sliding axially along the guide. An engageable lock may be positioned at the end of a sheath guide. The engageable lock may comprise one or more surfaces to engage with the end of the fiber optic cable (or cable assembly). The crawler may be configured to interact with the lock to engage the lock (e.g. after the fiber optic cable is inserted) or to disengage the lock (e.g. before removal of the fiber optic cable).

A guide may comprise a rail. A rail may be an elongate structure onto which a fiber optic cable (or other cable) can be attached along the length of the rail. The rail may facilitate sliding engagement with the fiber optic cable along the rail axis and prevent other movements of the fiber optic cable with respect to the rail. The rail may be configured to rigidly engage with the fiber optic cable to prevent any movement. The rail may comprise a foot for connecting to a structure, a web and a head (e.g. which may be wider than the web) to facilitate gripping to engage the fiber optic cable and hold it in place.

The rail may be attached to a structure to facilitate attachment of a fiber optic cable or cable assembly to the rail. The crawler may be configured to follow the course of the rail (e.g. by attaching a wheel to the rail or by following the rail using sensors). The fiber optic cable assembly may comprise engagement members to connect to the rail along the length of the fiber optic cable assembly. The engagement members may be resilient (e.g. so that they can deform in order to grip the rail) and/or openable and closeable (e.g. with jaws which, when closed, grip the rail). The crawler may be configured to open and close the engagement members.

The cable assembly may comprise multiple fiber optic cables.

The crawler may comprise a wired or wireless transceiver for transmitting data from the apparatus to a remote computer.

The crawler may be between 30 cm and 1.5 m in length.

The fiber optic cable may comprise one or more fiber Bragg gratings. The position of the fiber Bragg gratings and the indicia may have a known association. That is, the position of the fiber Bragg gratings may be determined from the position of the indicia and the route followed by the crawler as the fiber optic cable is laid.

The apparatus may be configured to cut an already laid cable (e.g. using one or more of a knife, blade, laser and pincer), connect on a new section cable to one of the cut ends, and affix the new section along the surface. In this way, the crawler may repair existing cabling. It will be appreciated that the location of a fault in fiber-optic cable may be determined by detecting distortion in the reflected signal. When the fault is identified, the crawler may be programmed to travel to that location, cut out a section of cable and replace the damaged section with a new section.

According to a further aspect, there is provided a method for laying cable to a surface, the method comprising:
moving a crawler along a surface;
storing a route followed by the crawler;
feeding a cable onto the surface by the crawler as the crawler moves along the surface; and
positioning a fastener with respect to the cable by the crawler as it is being fed onto the surface to affix the cable to the surface.

According to a further aspect, there is provided a fiber optic cable comprising:
a core and a cladding layer, wherein the core and/or cladding layer vary along the length of the cable; and
indicia positioned along the length of the cable; and
a flat side for connection to an underlying surface.

The variation of the core and/or cladding layer means that the response of the fiber optic cable to light passing along the cable will vary along its length. The variations may be mapped on to the indicia positioned along the length of the cable so that deformation detected at the position of a variation may be mapped on to the location of the structure. The variations may comprise changes in refractive index, or Bragg gratings.

The propulsion system may comprise continuous tracks (e.g. a continuous band of treads or track plates driven by one or more wheels).

The propulsion system may be configured to use suction to adhere the crawler to the surface.

Adhesion and locomotion are important functions of a climbing robot. Locomotion may be performed via mechanisms such as wheels, tracks or actuated legs. The crawler may use a variety of means to adhere to the surfaces they move along, including magnetic and electrostatic mechanisms, ducted fans, non-contact Bernoulli type attractors and vacuum adhesion mechanisms.

The crawler may comprise a cleaner configured to clean or remove a surface coating before the cable is laid (e.g. using steam or abrasion)

The crawler may comprise a protectant applicator configured to apply a surface protectant (either coating or the glue is double purposed to protect against corrosion).

The crawler may comprise a Lidar/laser scanner, and/or other sensors configured to perform other non-destructive tests.

The crawler may be configured to perform weld profile dimension scanning (New Construction Quality Control - Automatically follows weld seams).

The crawler may be configured to perform ultrasonic thickness/ weld defect testing and/or Magnetic Flux leakage for corrosion detection.

The crawler may comprise a coating thickness gauge.

The crawler may comprise a coating quality gauge.

The crawler may comprise one or more of the following:
prism lens (If Laser Tracker or guided system is utilized- known distance to structure surface from prism);
clearance arm;
adjustable cable feeder;
code reader;
installation or laydown arm;
wheel encoders;
pressure sensor;
tension sensor;
Cable basket or reel for containing the cable before installation;
swivel head;
suction head - or blower for surface preparation;
glue or adhesion applicator; and
lidar for reference point identification, collision avoidance and proximity approach

A clearance arm may be an elongate arm configured to keep the cable as it is being fed through the feeder. The clearance arm may help prevent the cable being tangled or wrapped around a wheel or something else.

The feeder cable may be adjustable to allow for a few different sizes of cables.

The feeder may comprise a swivel head may allow the crawler to switch directions during installation of the cable and lay cable while moving the opposite direction.

The suction head and/or blower head relate to surface preparation. These features may be configured to prepare the surface prior to the cable laydown, to increase adhesion and to help avoid manually accessing surfaces to prepare. A blower head would blow loose material (e.g. paint flecks) away, while a suction head would suck up loose material.

The crawler may be battery powered, be connectable to the mains and/or comprise a renewable power source (e.g. a solar panel).

A storage tank may comprise a container. A storage tank may comprise a floating roof. The container may comprise a shell (e.g. a wall configured to retain liquid), a floor and one or more internal columns. The floating roof comprises a rigid portion and one or more deformable seal assemblies. The rigid portion may comprise a float for allowing the roof to float on the liquid stored within the container. The container may comprise a fixed roof above the floating roof.

The structure may comprise components which are made of a deformable or resilient material. The deformable floating-roof seal assembly may comprise multiple rigid components which are connected together to allow relative movement between the rigid components to facilitate deformation (e.g. an articulated arm).

The deformable floating-roof seal assembly may be configured to reduce rim evaporation. The deformable floating-roof seal assembly may form a substantially airtight seal between the rigid section of the roof and the container.

The floating-roof seal assembly may comprise a skirt of resilient material. The skirt may be of unitary construction. The skirt may comprise multiple connected or overlapping sections.

The floating-roof seal assembly may comprise multiple skirts of resilient material.

The floating-roof seal assembly may be configured to span a gap between a rigid section of the floating roof and walls of a tank shell.

The crawler may be configured to lay the cable in an undulating manner. The undulation may be controlled by controlling the propulsion means and/or moving the feeder periodically as the crawler moves along (e.g. with the wheels moving forward in a fixed orientation either in a straight line or in a curve). The controller may be configured to store the route of the laid cable which comprises information relating to the route followed by the propulsion means and movement of the feeder relative to the propulsion means.

The feeder may be positioned centrally within the crawler. The feeder may be fixed within the crawler. The feeder may be adjustable to a number of a predetermined positions within the crawler (e.g. by the user). The feeder may be adjusted by the controller as the crawler is moving along (e.g. for fine adjustment of the route of the laid cable, or to place the cable in a position not reachable by a fixed feeder crawler, such as near a wall or barrier). For adjustable feeders, the controller may be configured to associate a route followed by the feeder with operation of the propulsion means and the position of the feeder within the crawler. The route will correspond to the position of the laid cable along its length. The crawler may comprise a feeder position sensor (e.g. in communication with the controller).

The apparatus may comprise a wireless transceiver for transmitting data from the crawler to a remote computer.

The fiber optic cable may comprise one or more fiber Bragg gratings.

The fiber optic cable may be configured to operate in one or more of the following modes: Rayleigh, Brillouin, Raman and time-of-flight.

The fiber optic cable may be configured to allow distributed chemical sensing based on the spatially resolved interaction of the light with the fiber optic cable.

A light receiver used in conjunction with the fibre optic cable may comprise a photodetector. The light receiver may comprise a time-resolved photodetector. The photodetector may comprise GaAs and/or InGaAs. The wavelength range of sensitivity of the light receiver may be between 500-1630 nm. The bandwidth of the light receiver may be between DC to 26 GHz.

The light receiver may be a optical sensing interrogator such as a Micron Optics™ sm125-500, 130-700 or si155 Standard; HBM™ FS22 or FS42; a Smart Fibers™ SmartScope FBG or SmartScan™ FBG; a FAZT 14G; a Optilab™ FSI-RM-18 or a BaySpec™ WaveCapture™; or a Ibsen™ I-MON.

The refractive index of fiber optic cable may be between 1.4 and 1.5. This corresponds to light speeds within the fiber optic cable, S_{fo}, of between 200 and 215 m/µs. To have meter resolution in a backscattering configuration, the photodetector would need to be able to distinguish signals received around 9-10 ns apart (2×1 m/s_{fo}). Apparatus with higher temporal resolution (e.g. in the picosecond range) would have a higher spatial resolution. The operating wavelength of the fiber optic cable may be between 1460-1650 nm.

The cable may be configured to facilitate both Distributed Fiber Sensing (DFS) and Distributed Chemical Sensing (DCS).

The crawler may be configured to identify areas of corrosion on the surface. Corrosion may affect the shape of the shell (e.g. if rust expands the surface of the shell inwards) or how the seals move across the surface of the shell (e.g. by changing the roughness or coefficient of friction of the shell).

The fiber optic cable may be a single-mode fiber or a multi-mode fiber.

The fiber optic cable may be multicore cable (e.g. the iXblue™ Multicore Fiber IXF-MC-7-SM-1550). For example, the multicore cable may comprise 7 cores in a hexagon & center configuration. Using multicore cable may allow the deformation of the sealing assembly to be more accurately determined because there would be multiple data streams for each position on the sealing assembly, and these data streams would be constrained and related to each other by virtue of the configuration of each core within the multicore cable.

The cable feeder may comprise opposed wheels or tracks configured to grab and feed the cable as they rotate together.

The propulsion means may be connected to a controller. The crawler controller may comprise a processor and memory. The memory may store computer program code. The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a cut-away perspective view of a floating-roof tank and a crawler navigating the tank surface.

FIG. 1b is a schematic side view of a crawler of FIG. 1a.

FIG. 1c is a schematic block diagram of the components of the crawler of FIG. 1b.

FIGS. 2a-d are transverse cross-sectional views of single core cable affixed to a surface.

FIG. 3a is a top view of a floating-roof comprising a further embodiment of an apparatus for measuring the deformation in a floating-roof seal assembly.

FIG. 3b is a schematic of a control unit of an embodiment of an apparatus for measuring the deformation in a floating-roof seal assembly.

FIG. 4 is a perspective view of a fiber optic cable assembly comprising three fiber optic cables with Bragg gratings.

FIG. 5 is a schematic view of a fiber optic cable assembly showing how bending curvature can be determined.

FIGS. 6 and 7 are cross-sectional views of two fiber optic cable assemblies.

### DETAILED DESCRIPTION

### Introduction

The present technology relates to the installation of fiber optic, instrumentation, control and electrical lines onto structural surfaces (such as a tank) via robotic crawler or surface unmanned drone.

Installation of industrial cabling is generally installed manually with Instrumentation, Communications or Electrician tradesman. This may take significant time and equipment. Instrumentation or electrical components, conduits, clips, fasteners, bolting, cable trays and supports are subject to manual inaccuracies.

Cabling and sensors may be needed or wanted are in many inaccessible areas which require the cost equipment and service providers consisting of mechanical manlifts, scaffolding, platforms, ladders and rope access. The continuous need for these makes them an expensive current cost presence in industry.

Regular maintenance is required to service materials, trays and conduits.

Installation of cable lines still falls very short on the known placement and location of the lines or sensors versus accurate 3D models. Compatibility often does not match up with the different selection of material components and the systems are not compatible or integrated with other systems or dashboards.

Traditional cable mapping is performed with inspectors, instrumentation trades or engineers walking lines and drawing sketches of the locations and design.

In the past these shortcomings have been addressed in the last decade in part with new wider varieties of manlifts, scaffolding and industrial rope access techniques and tools. These may slightly improve accessibility and safety but do not reduce the overall cost of service.

The high cost for scaffolding, manlifts, rope access techniques and temporary platforms are still present. These in-person services and equipment carry an associated risk to the tradespeople.

Although 3D models have more accuracy than manual hand drawn sketches the costs of time, equipment, materials, training, extra review, and data management/systems are needed. 3D Models are overlapped multiple times during a variety of different conditions, which in turn reduce the overall accuracy and even increase the time/cost associated with additional client review.

The inventors have realized that using a crawler to lay the cable reduces the need to have people working on the structures, and may provide a better way of accurately, quickly and easily mapping the route or path of the cable as it is laid/installed.

One example of where a cable needs to be installed is using a fiber optic cable attached along its length to a floating-roof seal assembly to monitor deformation of the floating-roof seal assembly. Deformation of the fiber optic cable and the seal assembly can be determined based on how the light interacts with the fiber optic cable. This helps allow tanks with a floating roof to be monitored.

This may help to enhance storage tank owner’s ability to protect the environment in line with the mandatory environmental protection agencies (such as the EPA) and greatly improve the efficiency of Industrial Code Compliance. This technology may help enable continuous monitoring of the storage tank’s floating roof, seals, shell deformation, shell settlement and internal column/pillar status.

Monitoring deformation in this way may reduce the need for a tank to be taken out of service. A single tank being out-of-service cost owners and producers anywhere from $8,000 to $500,000USD per day.

Floating roof seals typically are required to be inspected every year at a minimum for their tightness against the shell. In the U.S. if they are not compliant the EPA requires the owners to repair, adjust the seals or repair the tank to bring the tank back into compliance. The EPA generally gives only 45 days for the repair to be complete before fines are issued. The continuous monitoring of the seals may allow tanks to be tracked and operators notified of potential problems in advance to allow them to have more time to meet the regulatory requirements.

Existing inspection schedules have been unsatisfactory because they still all depend on inspection time intervals, have high costs, put inspectors in potentially dangerous situations, only capture a relatively small amount of data, do not turn around data fast enough to the clients and are not integrated enough to really enhance the owner, engineer, inspector and data collector.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Floating Roof Tank

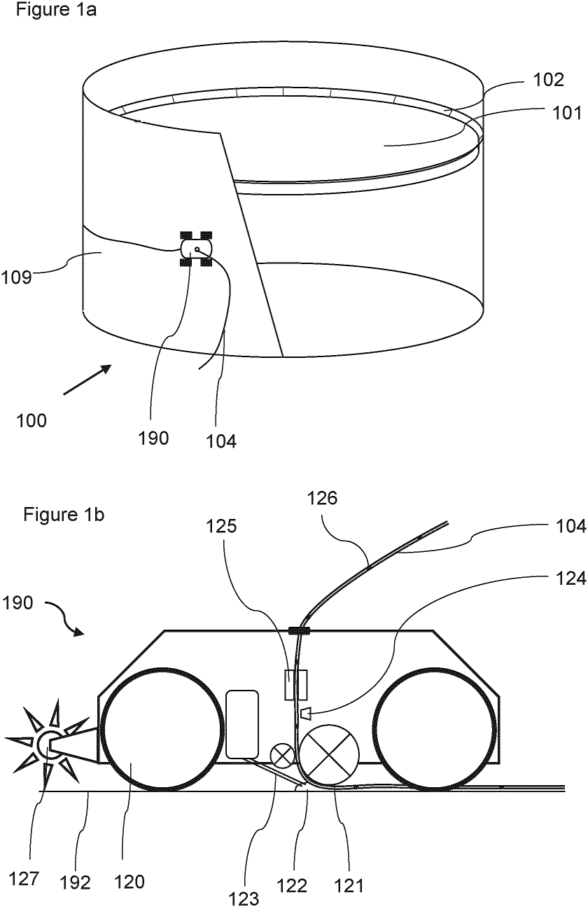

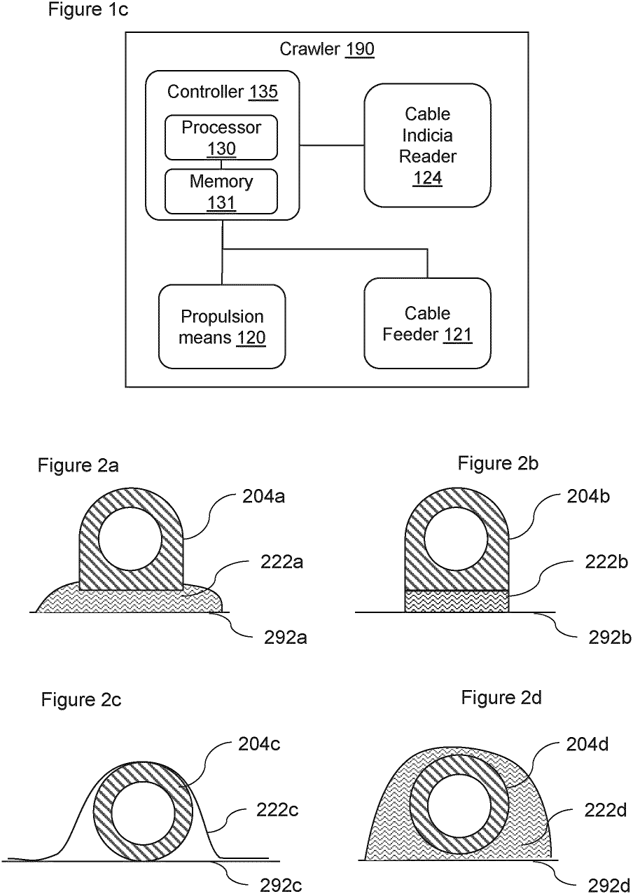

FIG. 1a shows a perspective cut-away view of an embodiment of an external floating roof tank 100. A floating roof tank is a storage tank which is commonly used to store large quantities of petroleum products such as crude oil or condensate. In this case, the tank comprises an open-topped cylindrical steel container with a shell 109 equipped with a roof 101 that floats on the surface of the stored liquid. The roof rises and falls with the liquid level in the tank.

In this case, the roof comprises a deformable seal 102 which spans the gap between a rigid section of the floating roof and the shell 109 to help prevent gas from escaping from the tank.

In some embodiments, the roof may have support legs hanging down into the liquid. These allow the roof to land at low liquid levels the roof which then allows a vapor space to form between the liquid surface and the roof, like a fixed roof tank.

FIG. 1a also shows a crawler 190 as it navigates the surface of the tank to lay a fiber optic cable 104. It will be appreciated that the crawler may be configured to lay cable on a wide range of structures (e.g. buildings, fixed tanks, cranes, maritime oil rigs etc.).

### Crawler

Manually interacting with large-scale structures such as the tank shown in FIG. 1a can be difficult. It may require significant amounts of manlift machinery, rope access and scaffolding. Tasks which may be required may include construction, upgrading, monitoring and maintenance.

In some instances, some of the tasks normally performed manually may be performed remotely using robots (e.g. crawlers). Robotics represent many of the safest, cost effective, accurate and repeatable solutions. Robots or Drones can be manually operated, autonomous, or semi-autonomous with human supervision. Approved robotics can be configured, using the 3D model of the structure (or digital twin), to follow particular paths with very accurate precision and to perform particular tasks.

FIGS. 1b and 1c show a crawler 190 for laying cable 104 (e.g. onto the tank surface 190 of FIG. 1a) comprising:
propulsion means 120 configured to move the crawler 190 along a surface 192;
a controller 135 configured to associate a route followed by the crawler with operation of the propulsion means 120;
a cable feeder 121 configured to feed a cable onto the surface as the crawler moves along the surface; and
a fastener applicator 123 configured to position a fastener 122 with respect to the cable 104 as it is being fed onto the surface 192 to affix the cable to the surface.

In this case, the propulsion means comprises fourwheels which are magnetic. The magnetic wheels are configured to exert an attractive force greater than the weight of the crawler when the crawler is attached to a steel structure. In this case, both the back wheels and the front wheels are steerable. In addition, the wheels are also orientable to allow rotation of the crawler about a central axis without translating the crawler. The cable feeder in this case is configured to feed the cable onto the surface at a positioned aligned with the central axis.

In this case, the controller is configured to record operation of the propulsion means as it moves along a route. In this case, this is done by measuring the angular position of the wheels about the wheel axis, and the orientation of the wheels about a steering axis using an encoder. Using these values, the controller is configured to calculate how the position of the cable feeder moves as the propulsion means is controlled by a remote controller. This allows the route of the cable to be recorded along its length. A wheel axis is the axis about which the wheel rotates around to move forwards or backwards (e.g. transverse to or through the plane of the wheel). A steering axis is the axis about which the which the wheel rotates to steer (e.g. aligned with the plane of the wheel).

As shown in FIG. 1c, the crawler controller 135 comprises a processor 130 and memory 131. The memory comprises computer program code to be run by the processor in order to perform the functions described.

It will be appreciated that some embodiments may also be configured to measure the height of each wheel with respect to the chassis and/or the height of the chassis from the underlying surface. This may allow curvature of the underlying surface to be determined. Other embodiments may be configured to record operation of the propulsion means indirectly by measuring the movement of the surface below the crawler as it moves along. E.g. the crawler may comprise a digital signal processor (DSP) camera for monitoring movement of the surface below the crawler (and possibly a light source for illuminating the surface).

As the crawler moves along, a free fiber optic cable is fed into the crawler. In this case, the fiber optic cable comprises a core and a cladding layer, wherein the core and cladding layer vary along the length of the cable; indicia 126 positioned along the length of the cable; and a flat side for connection to an underlying surface.

In this case, the core and cladding vary along the length of the cable by having Bragg gratings positioned at various locations along the length of the cable. The positions of these Bragg gratings with respect to the indicia are known.

After being fed into the crawler, an orientation means 125 is configured to orient the cable before it is fed onto the surface. In this case, the orientation means is configured to orient the flat side of the cable such that the flat side is facing the surface when the cable is fed onto the surface. The flat side serves two functions: it permits a broader surface with which to affix the cable to the surface; and it helps control the cable orientation along its length (e.g. which helps prevent torsion within the cable).

In this case, the crawler comprises a reader 124 is configured to read each indicium 126, wherein the controller is configured to associate the read indicium with a position along the route. This allows the position of the Bragg gratings (or other variations in the cable) to be associated with positions along the route.

In this case, the feeder 121 comprises two wheels configured to place the cable onto the surface. Ahead of the position that the cable is placed onto the surface is a fastener applicator 123 which is configured to apply liquid glue to the surface. The feeder then feeds the cable onto this glue to affix the cable to the surface along its length. The crawler is configured to apply a force to the cable to ensure a secure contact with the glue and the underlying surface. The crawler may comprise a force sensor to measure the force applied to the cable as it is being laid.

The crawler in this case comprises a cleaner 127 configured to clean a portion of the surface prior to application of the cable. The cleaner is a brush cleaner configured to clean the surface in advance of where the cable will be laid. This helps ensure a secure contact between the cable and the surface.

### Fiber Optic Attachment

FIGS. 2a-d are transverse cross-sectional views of single core cable affixed to a surface.

FIGS. 2a and 2b show cable with a flat side which is oriented towards the surface to allow better adhesion.

In FIG. 2a, a layer of liquid glue 222a is applied to the surface 292a and a flat side of the cable 204a is then pushed into the liquid glue by the crawler. This affixes the cable to the surface.

In FIG. 2b, a layer of solid glue 222b is attached to the cable 204b in advance (e.g. possibly protected by a protective layer). As the cable is laid, the protective layer may be removed, and the solid glue is pushed onto the surface 292b by the crawler. This affixes the cable to the surface.

In FIG. 2c, the cable 204c is laid on the surface 292c and then a layer of adhesive tape 222c is applied over the cable such that a portion of the tape adheres to the surface on either side of the cable.

In FIG. 2d, the cable 204d is laid on the surface 292d and then a layer of liquid adhesive glue 222d is applied over the cable the adhesive surrounds the cable and adheres the cable to the surface.

It will be appreciated that the liquid glue may take time to cure after application. The speed of the crawler may be dependent on the curing rate of the glue. In this context, liquid glue may encompass any glue which can flow before it is cured. This includes materials which are relatively viscous.

The glue may comprise a resilient adhesive such as cyanoacrylate adhesives. For improved flexibility Permabond 731, 735, 737 or 2050 may be used.

### Fiber Optic Line

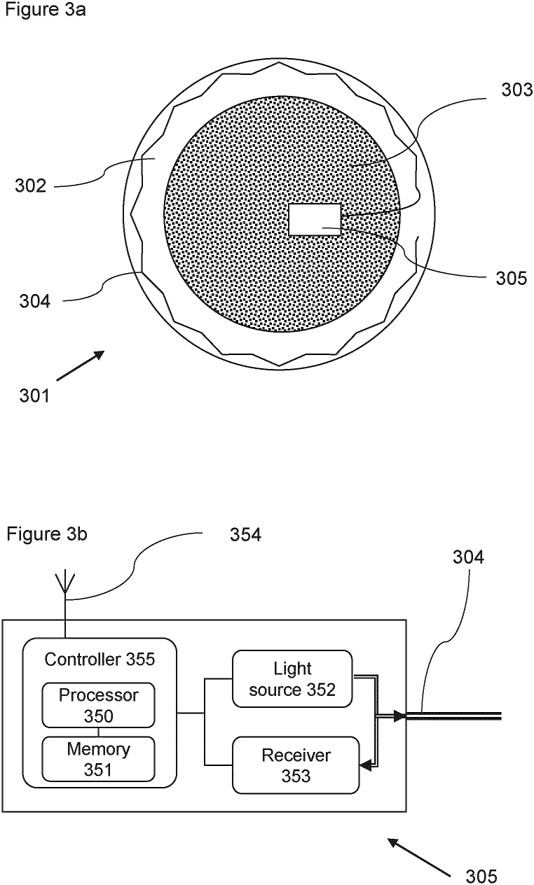

FIG. 3a is a schematic top view of a floating roof which could be used with the tank of FIG. 1a. In this case, the size of the seal assembly 302 has been shown relatively larger than the rigid roof section for greater clarity. In conventional tanks, the rigid roof section 303 may be between 100 to 300 ft diameter. The space between the rigid roof section 303 and the shell may be typically 5-20 inches (e.g. 10±4 inches). The rigid section in this case comprises floats to allow the roof to float on the liquid contained within the container.

FIGS. 3a and 3b depicts an apparatus for measuring the deformation in a floating-roof seal assembly comprising:
a deformable floating-roof seal 302 assembly configured to span between a rigid section 303 of a floating roof 301 and components of a tank shell;
a fiber optic cable 304 attached along its length to the floating-roof seal assembly 302 such that the fiber optic cable is deformed when the floating-roof seal assembly is deformed;
a light source configured to transmit light along the fiber optic cable; and
a receiver configured to detect light from the fiber optic cable after it has interacted with the fiber optic cable.

The cable in this case is installed by the crawler of FIG. 1b. It will be appreciated that, to install a cable on a substantially horizonal surface, supplementary attraction means (e.g. magnets or suction) may not be required to hold the crawler onto the surface as the crawler’s weight may be enough. Nevertheless, supplementary attraction means may allow a greater force to applied to the cable during installation, if required.

In this case, the light source and receiver are contained within a control unit 305. The control unit comprises a fiber optic controller 355 comprising a processor 350 and a memory 351. The memory may comprise computer program code to be run on the processor to control the light source 352 and to process the data generated by the receiver 353.

In this case, the floating-roof seal assembly comprises a skirt 302 of resilient material. The floating-roof seal assembly is configured to span a gap between a rigid section of the floating roof and walls of a tank shell.

As the roof 301 moves with respect to the shell, the skirt deforms. As the floating-roof seal assembly deforms, the fiber optic cable, which is attached along its length to the floating-roof seal assembly, also deforms. This allows the deformation of roof movement with respect to the shell to be monitored and recorded. The fiber optic cable may be between 200 ft and 1.5 km.

It will be appreciated that there may be several reasons why the roof is moving with respect to the shell, and each may have particular deformation characteristics.

In this case, the fiber optic cable is installed around at least ¾ of the diameter of the floating roof. Generally, the greater proportion of the diameter of the tank is monitored, the more accurate the results may be. In this case, the apparatus has a single fiber optic line. In other embodiments, the apparatus may comprise multiple lines, each of which detect deformation in a different azimuthal range of the seal assembly. For example, one embodiment may have four fiber optic lines, each being configured to detect deformation in a different quadrant of the floating roof seal assembly.

In this case, the fiber optic cable comprises one or more fiber Bragg gratings. A fiber Bragg grating (FBG) is a type of distributed Bragg reflector constructed in a segment of optical fiber that reflects particular wavelengths of light and transmits all others. This is achieved by creating a periodic variation in the refractive index of the fiber core, which generates a wavelength-specific dielectric mirror. A fiber Bragg grating can therefore be used as an inline optical filter to block certain wavelengths, or as a wavelength-specific reflector.

In this case fiber optic cable 304 undulates with respect to a sealing axis of the seal assembly. The sealing axis, in this case, is a circular axis which extends around the diameter of the roof. That is, the sealing axis in this case is an axis of constant radius around the roof where the seal interacts with the shell. In this case, the undulations describe how, as you move around the sealing axis (with increasing azimuthal angle), the distance between the fiber optic cable cyclically increases and decreases.

The crawler of FIG. 1b may be used to affix the cable 304 along the undulating path shown in FIG. 3a. It will be appreciated that, in some embodiments, a user may actively control the crawler in order to lay the track in a particular path. In this case, the crawler was configured to navigate along the seal in an undulating manner between the outer shell wall of the tank and the inner rigid section of the floating roof. As the cable was being laid, the crawler is configured to record the position of the cable and associate this position with indicia read from the cable as it is being laid. This allows the system to have a clear mapping between a distance along the length of the cable and a position on the surface.

The undulating arrangement may have a number of advantages. Firstly, in many cases, because the seal is deformable, there may be situations where tensile strain is applied along the length of the fiber optic cable which may be damaging to the cable. The undulations may an expansion in the sealing assembly parallel to the sealing axis to be accommodated by straightening out the undulations rather than applying a tensile strain to the fiber optic cable along its length.

Secondly, the sealing assembly may have a number of modes of deformation. For example, if the roof is moving upwards and downwards within the shell, the skirt in this case will deform upwards and downwards, but there will be much smaller deformations around the sealing axis because every point of the skirt around the diameter will be experiencing forces. In this case, a fiber optic cable which runs parallel to the sealing axis may be less sensitive to deformations which affect all points in the seal in the same way.

In this case, the Bragg gratings may be configured to be arranged in the sections of the fiber-optic cable which is not parallel to the sealing axis (e.g. the sections which are at angle to the sealing axis).

In some embodiments, the system may be configured to adjust the path of the cable based on indicia read from the cable. For example, a Bragg grating may be positioned between successive indicia. In such an embodiment, the crawler may be configured to continue in a straight line and then turn alternately right and left when an indicium is read. This will create an undulating zig-zag path with the Bragg gratings positioned in the straight sections between the bends.

### Fiber Optic Control Unit

FIG. 3b shows a schematic representation of the fiber optic control unit 305 which may be used in conjunction with other embodiments described herein. The control unit 305 comprises a light source 352 configured to generate light which is directed into the fiber optic cable 304. In most cases, this light source will be a laser.

The control unit also comprises a light receiver 353 (e.g. a photodetector) configured to detect light from the fiber optic cable. The light received will contain artefacts which are due to how the fiber optic cable has been deformed. In many cases, the light received will be back-scattered light.

In this case, the apparatus control unit 305 comprises a controller 355 comprising a processor 350 and memory 351. The memory on this case comprises computer program code configured to be run on the processor. The computer program code may be stored on a non-transitory medium (e.g. CD or DVD).

The controller 355 in this case is configured to:
receive data from the receiver 353; and
determine a measure of spatially resolved deformation of the fiber optic cable 304 based on the received data.

In this case, spatially resolved means that the detected deformation is associated with a particular length along the fiber optic cable axis. As how the fiber optic cable is connected to the seal assembly is known, this information can be used to deduce how the seal assembly is being deformed.

As discussed in Lu et al. (A Review of Methods for Fibre-Optic Distributed Chemical Sensing, Sensors 2019, 19, 2876; doi:10.3390/s19132876), DCS, as a distributed fiber sensing (DFS) technique, is capable of employing the entire optical fiber as the sensing element and of providing measurements with a high degree of spatial density. The spatial information is usually resolved through optical time domain reflectometry (OTDR) or optical frequency domain reflectometry (OFDR). In an OTDR apparatus, an optical pulse is launched into the fiber, and the backscattered light intensity is measured as a function of time.

The distance along the fiber to which a given backscatter component corresponds is determined by time-of-flight considerations, and the spatial resolution is commonly defined as half of the pulse length. Finally, the obtained signal is processed to retrieve the spatial information. That is, the fiber optic controller 355 is configured to determine that a deformation is occurring a particular length along the fiber optic cable. Knowledge of the 3-dimensional path of the cable allows the position of the deformation to be determined.

The backscattered signal comprises Rayleigh, Raman, and Brillouin scattering processes inside an optical fiber. Different types of distributed sensor are often classified in terms of what backscattered component they are designed to measure. Rayleigh scattering is an elastic process, in which there exists no energy transfer between the incident light and the medium; thus, the backscattered light exhibits no frequency shift compared to the laser input. On the other hand, inelastic scattering, e.g., Brillouin and Raman scattering, requires an energy exchange between the light and the material; thus, the frequency of the scattered light is expected to shift from the incident light. For silica fibers with an incident light at 1550 nm, the frequency shifts of Brillouin scattering and Raman scattering are about 11 GHz and 13.2 THz, respectively.

In this case, the apparatus comprises a wireless transceiver 354 for transmitting data from the apparatus to a remote computer.

In this case, the apparatus is configured to continuously monitor deformation. Interrogators can sample at very high rates. 500 msec would allow many sensors to be monitored at once

Deformations may be detected using a multicore cable (e.g. 7 core). The shape is discerned by differences in strains between the individual fibers. This requires the proper orientation of the fibers (which may be facilitated by orienting the fiber as it is installed).

### Fiber Optic Cable Configuration

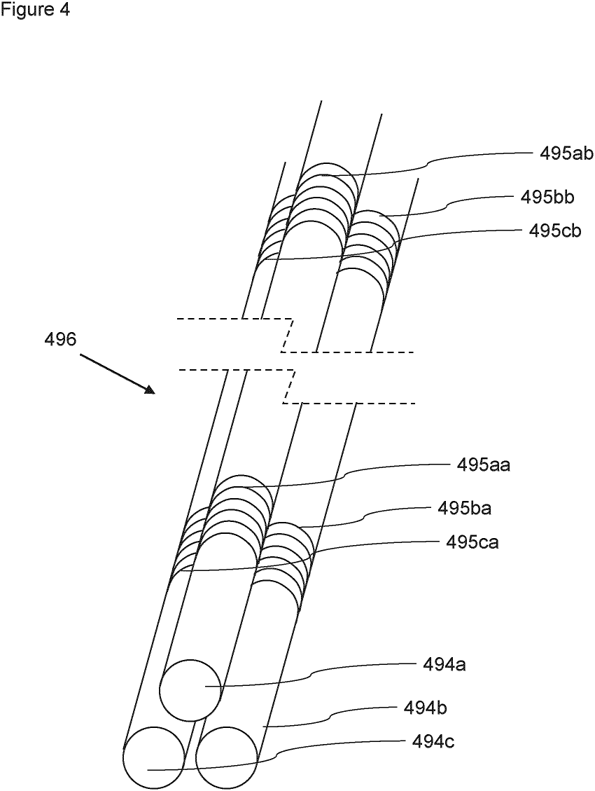

FIG. 4 shows a configuration of three fiber optic cables 494a-c forming part of a fiber optic cable assembly 496. In this case, the cables are arranged in a triangle configuration. Each cable comprises a series of Bragg gratings 494aa-ab, 494ba-bb, 494ca-cb which are aligned with each other. That is, the multiple fiber optic cables comprise respective Bragg gratings which are positioned at the same axial distance along the cables so that information about the same part of the tank can be determined from the Bragg gratings of the multiple fiber optic cables.

The Bragg gratings may be spaced apart between 0.25-1 meters (center to center) along the cable axis. Each cable may comprise at least 10 Bragg gratings. Each cable may have fewer than 50 or fewer than 100 Bragg gratings. Each Bragg grating may have a length of between 5 and 20 mm (e.g. 10 mm) along the axis of the cable.

The fiber optic cable may comprise a Technica™ T130 cable. The cable may be configured to use wavelengths of more than 1532 nm continuous wave with a wavelength tolerance of ±0.5 nm or less. The bandwidth of the light source (full width half maximum -FWHM) may be less than 0.2 nm.

Increasing the spacing between the fiber optic cables may increase the sensitivity of the sensors. The center to center spacing between neighboring fiber optic cables may be between 1 and 3 mm. A center to center spacing of 2 mm is known to provide a curvature resolution of 3.6 × 10⁻³ m⁻¹.

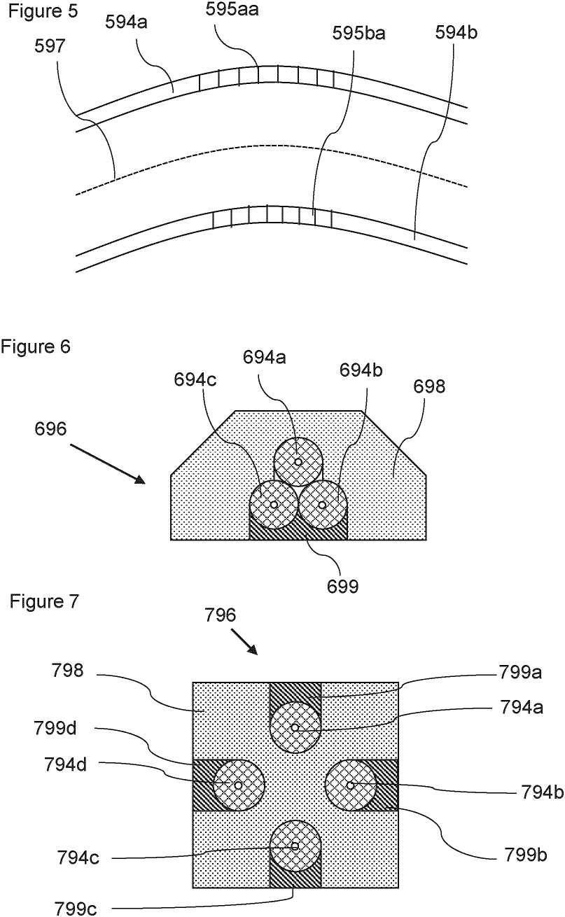

The cable assembly design is based on the bend measurement differential principle by means of two Bragg Grating elements located on different sides of its structure (see FIG. 5). In this case, the figure shows how curvature in the plane of the page can be measured by two fiber optic cables 594a, 594b arranged on either side of a fiber optic cable assembly axis 597. Each cable comprises a respective Bragg grating 595aa, 595bb arranged at the same length along the optic cable assembly axis 597.

In the situation depicted in FIG. 5, the fiber optic cable assembly is bent downwards at either side. This causes tension in Bragg grating 595aa in the upper fiber optic cable 594a which increases the Bragg grating spacing; and compression in the Bragg grating 595ba in the lower fiber optic cable 594b which decreases the Bragg grating spacing. The difference in the change in Bragg grating spacings allows a measure of the curvature in the optic cable assembly axis 597 to be determined.

Such an arrangement of the sensing elements increases the measurement accuracy and reduces the temperature influence, since it is the difference between different fiber optic cable readings that is used to measure the magnitude of the deformation, rather than absolute values. Measuring the magnitude of the bend in two directions requires the use of at least three sensing elements (e.g. in the plane of the seal and perpendicular to the plane of the seal).

FIGS. 6 and 7 show two separate cross-sections of two cable assemblies 696 and 796.

Both the fiber optic cable assemblies 696, 796 use multiple single-core fiber optic cables 694a-c, 794a-d mounted within a substrate 698, 798. In these cases, the substrate is silica glass or acrylate. The substrate is extruded to facilitate mass production. In both cases, the substrate 698, 798 comprises one or more slot for receiving one or more fiber optic cables. The slots are shaped to hold the fiber optic cables in a particular configuration with respect to each other. The substrate may comprise one or more flat surfaces to facilitate attaching the cable assembly to a structure (e.g. to a tank wall or seal assembly) and orientation of the cable assembly during installation by a crawler.

In the fiber optic cable assembly 696 of FIG. 6, there is one slot which is shaped to receive three fiber optic cables 694a-c in a triangle configuration. The slot has a shaped surface so that the first fiber optic cable inserted abuts a curved surface which holds it in place. The remaining two are held in place by abutting: other curved surfaces of the substrate; the first fiber optic cable; and each other.

In contrast, in the fiber optic cable assembly 796 of FIG. 7, there is one slot for each of the four fiber optic cables 794a-d. These slots ensure that the four fiber optic cables are held in a quadrilateral (e.g. square) configuration.

Both the fiber optic cable assemblies 696, 796 use reinforced fiber optic cables. In these cases, each fiber is coated with acrylate and configured to have a 1 mm outside diameter.

Because the fiber optic cables 694a-c abut each other in the embodiment of FIG. 6, the spacing between cables is dictated by the outer diameter of the reinforcing (1 mm in this case). Other diameters may be used (e.g. between 1 and 3 mm) to adjust the sensitivity of the assembly.

By having separate slots, as in the embodiment of FIG. 7, the inter-cable spacing can be adjusted more easily. In the embodiment of FIG. 7, the center to center spacing of neighboring cables (e.g. between cables 794a and 794b) is 1.77 mm.

Both assemblies are configured to hold the fiber optic cables within the substrate using a bonding agent 699, 799a-d, such as acrylate-silica glass or acrylate-acrylate bonding. The bonding can act as an anchor for the fiber Bragg gratings.

### Other Options

The crawler may be manually operated, path programmed and or laser tracker connected. The crawler may be configured to store the route of where the cabling is installed. The crawler/remote device may be configured to automatically update the 3D models in the system.

The crawler may be configured to follow a predetermined structure on the surface (e.g. to place a cable with respect to a weld or a wall).

The crawler may be configured to provide one or more of the following: x- and y-coordinates for a cable, z-coordinates for a cable, calibration information required for a system, ambient conditions at the time of installation, inspection results along the sensor or cable line and reference points for manual verification. It will be appreciated that, as a surface is 2 dimensional, the path may be defined in terms of its route along that surface in 2 dimensions. In other embodiments, the path may be defined in 3 dimensions which express the route of the cable independently of the surface.

The crawler may be configured to install cable by way of fastening, glue, weld tack, jacket fusion, adhesive or clip connection. The cable may be one or more of fiber optic cable, communications cable, instrumentation cable, and electrical cable.

The crawler may be laser guided.

Single or Multi-phase Fiber Optic cable may be used as a sensor for a Storage Tank Floating Roof Seal, Rim Space components and spacing around floating roof penetrations such as columns and gauge poles. Distributed fiber-optic sensing arrangement may utilize the Fiber Bragg Grating (FBG) as well as the Distributed chemical sensing (DCS).

The cable may be configured to allow distributed chemical sensing based on the spatially resolved interaction of the light with the fiber optic cable.

The cable may be attached along its length to the outside of a container or tank shell. For example, a fiber-optic cable sensor may be positioned on or adjacent to a weld and/or towards the bottom of the tank. This may allow settling of the tank to be measured more directly.

Although the present invention has been described and illustrated with respect to preferred embodiments and preferred uses thereof, it is not to be so limited since modifications and changes can be made therein which are within the full, intended scope of the invention as understood by those skilled in the art.

1. A crawler for laying cable comprising:
propulsion means configured to move the crawler along a surface;
a controller configured to store a route followed by the crawler as it moves along the surface;
a cable feeder configured to feed a cable assembly onto the surface as the crawler moves along the surface; and
a fastener applicator configured to position a fastener with respect to the cable assembly as it is being fed onto the surface to affix the cable assembly to the surface.

2. The crawler of claim 1, the controller is configured to control the propulsion means along a predetermined stored route.

3. The crawler of claim 1, the controller is configured to record the route as the crawler moves along.

4. The crawler of claim 1, wherein the propulsion means is magnetic.

5. The crawler of claim 1, wherein the propulsion means comprises wheels.

6. The crawler of claim 1, wherein the crawler comprises a reader configured to read indicia from the cable assembly as the cable assembly is being fed onto the surface.

7. The crawler of claim 6, wherein the reader is configured to read each indicium, and wherein the controller is configured to associate the read indicium with a position along the route.

8. The crawler of claim 1, wherein the crawler comprises an orientation means configured to orient the cable assembly before it is fed onto the surface.

9. The crawler of claim 8, wherein the crawler comprises an orientation means is configured to orient a flat side of the cable assembly such that the flat side is facing the surface when the cable assembly is fed onto the surface.

10. The crawler of claim 1, wherein the fastener applicator is configured to apply liquid glue to the surface and the cable assembly to fasten the cable assembly to the surface.

11. The crawler of claim 1, wherein the cable feeder is configured to feed a cable assembly comprising a fastener and a fastener protective layer, and wherein the fastener applicator is configured to remove the protective layer to expose the fastener as the cable assembly is fed onto the surface.

12. The crawler of claim 1, wherein the crawler comprises a cleaner configured to clean a portion of the surface prior to application of the cable assembly.

13. The crawler of claim 1, wherein the crawler comprises a reel configured to hold the cable assembly and direct the cable assembly into the feeder.

14. The crawler of claim 1, wherein the cable assembly is a fiber optic cable.

15. The crawler of claim 1, wherein the apparatus comprises a wired or wireless transceiver for transmitting data from the apparatus to a remote computer.

16. The crawler of claim 1, wherein the fiber optic cable comprises one or more fiber Bragg gratings.

17. The crawler of claim 1, wherein the crawler comprises a curing means configured to interact with liquid glue to speed curing.

18. The crawler of claim 1, wherein the feeder is mounted on an axis between two wheels which have a fixed steering angle with respect to the axis.

19. A method for laying cable to a surface, the method comprising:
moving a crawler along a surface;
storing a route followed by the crawler;
feeding a cable assembly onto the surface as the crawler moves along the surface; and
positioning a fastener with respect to the cable assembly as it is being fed onto the surface to affix the cable assembly to the surface.

20. A fiber optic cable assembly comprising:
a fiber optic cable having a core and a cladding layer, wherein the core and cladding layer vary along the length of the cable;
indicia positioned along the length of the cable; and
a flat side for connection to an underlying surface.
